(19) United States
(12) Patent Application Publication
(10) Pub. No.: US 2026/0060215 A1
(43) Pub. Date: Mar. 5, 2026

(54) TOY BALL WITH DETACHABLE ACTUATION MODULE AND E-TPU ELASTIC SHELL

(71) Applicant: SHENZHEN CHEERBLE TECHNOLOGY CO., LTD., Shenzhen (CN)

(72) Inventors: Weicheng Guo, Shenzhen (CN); Jinbin Xie, Shenzhen (CN)

(21) Appl. No.: 19/384,064

(22) Filed: Nov. 10, 2025

(30) Foreign Application Priority Data
Jan. 15, 2025 (CN) 202520104542.7

(51) Int. Cl. A01K 15/02; A63B 39/06; A63B 43/04

(52) U.S. Cl. CPC A01K 15/026; A63B 39/06; A63B 43/04; A63B 2220/803

(57) ABSTRACT

A toy ball includes an clastic shell that defines a receiving cavity and an actuation module mounted in the cavity. The actuation module is detachably connected to the clastic shell and provides driving force to roll and/or enhance bouncing. The clastic shell includes expanded thermoplastic polyurethane (E-TPU) to provide low weight, high rebound, and compressive resistance.

### CROSS-REFERENCE TO RELATED APPLICATION(S)

The present application claims the benefit and priority to Chinese Patent Application Serial No. 202520104542.7, filed on Jan. 15, 2025, in China National Intellectual Property Administration, and the content of which is hereby fully incorporated by reference into the present application.

### FIELD

The subject matter relates to pet toys, particularly, to a toy ball including a detachable actuation module and an elastic shell including expanded thermoplastic polyurethane.

### BACKGROUND

Pet toys encourage pets to exercise, but since pets may bite and chew the pet toys, the pet toys can be easily damaged. As a result, the service life of the pet toys is reduced.

### BRIEF DESCRIPTION OF THE DRAWINGS

Implementations of the present technology will now be described, by way of example only, with reference to the attached figures, wherein:

FIG. 1 is a schematic view of an overall structure of a toy ball according to an embodiment of the present application.

FIG. 2 is a schematic view of an internal structure of the toy ball in FIG. 1.

FIG. 3 is a front view of an actuation module of the toy ball in FIG. 1.

FIG. 4 is a cross-sectional view taken along line A-A of FIG. 3.

FIG. 5 is a side view of the actuation module in FIG. 3.

FIG. 6 is a schematic view of a first half shell of the toy ball in FIG. 1.

FIG. 7 is a schematic view of a second half shell of the toy ball in FIG. 1.

FIG. 8 is a sectional view of an elastic shell of the toy ball in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

For clarity, terms such as “first,” “second,” etc. are used for distinction and do not limit the scope. Unless otherwise stated, a first direction X, a second direction Y, and a third direction Z may be mutually perpendicular. The drawings are schematic and not necessarily to scale.

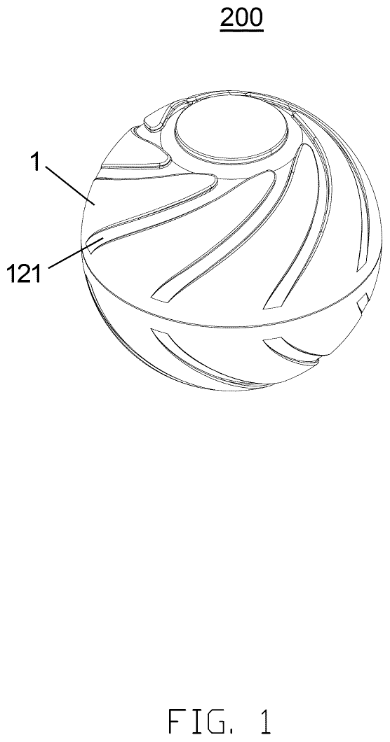

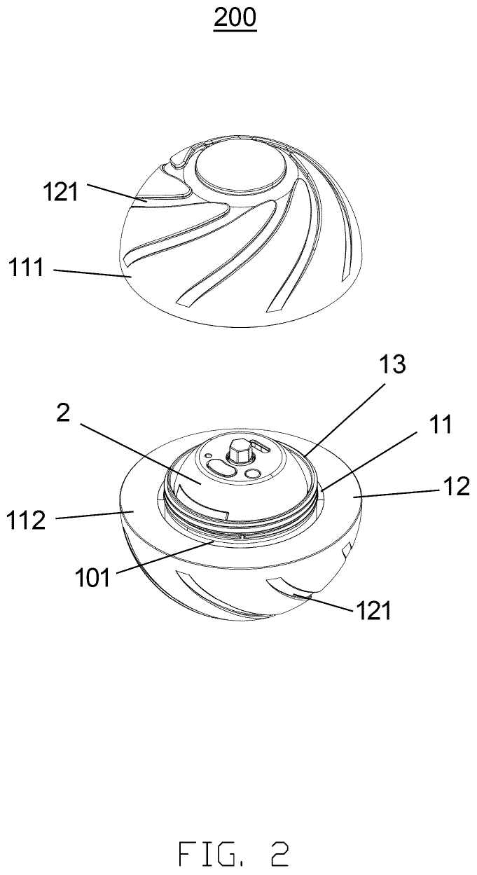

Referring to FIGS. 1 and 2, a toy ball 200 is provided according to an embodiment of the present application. The toy ball 200 includes an actuation module 2 and an elastic shell 1. The actuation module 2 is configured to provide a driving force to drive the elastic shell 1 to move. The elastic shell 1 defines a receiving cavity 101. The actuation module 2 is mounted in the receiving cavity 101 and is detachably connected to the elastic shell 1. The elastic shell 1 is made of expanded thermoplastic polyurethane (E-TPU).

In an embodiment, the elastic shell 1 is a hollow spherical structure. The actuation module 2 can be placed in the elastic shell 1 and connected to the elastic shell 1 to maximize use of an overall space. When the actuation module 2 was engaged, the toy ball 200 was driven to rise and then fall, the elastic shell 1 is compressed during an impact from the ground and stores elastic potential energy. The elastic potential energy causes the toy ball 200 to rebound so that the toy ball 200 repeatedly bounces to attract attention from the pet and to interact with the pet. The elastic shell 1 of E-TPU has low density and good compressive performance, so when the actuation module 2 applies force to the elastic shell 1, the toy ball 200 bounces higher. The actuation module 2 is detachably connected to the elastic shell 1 so that an owner can replace the elastic shell 1 with different colors or patterns.

In operation, when the actuation module 2 outputs a driving force to move the toy ball 200, during the movement, the elastic shell 1 repeatedly contacts the ground and is compressed to increase elastic potential energy. The elastic potential energy then causes the toy ball 200 to rebound, and under repeated driving, the bouncing of the toy ball 200 becomes apparent. In addition, the actuation module 2 can adjust the driving force of the toy ball 200 by changing an output magnitude, output duration, or output interval to provide more motion patterns.

With the above configuration, the toy ball 200 is resistant to biting from the pet and exhibits good elasticity. The toy ball 200 includes the actuation module 2 that provides the driving force and the elastic shell 1 that wraps around the actuation module 2. The actuation module 2 provides the driving force so that, without human contact, the toy ball 200 can roll or bounce autonomously. The elastic shell 1 is made of materials including E-TPU. The E-TPU material provides environmental friendliness, wear resistance, heat resistance, low-temperature resistance, light weight, high rebound resilience, and compressive resistance. The wear resistance of E-TPU makes the toy ball 200 less likely to be damaged after bitten by a pet. The environmental friendliness of E-TPU alleviates concerns regarding ingestion of toxic substances by the pet. The light weight, high rebound resilience, and compressive resistance of E-TPU enable the actuation module 2 to drive the toy ball 200 to bounce and roll to a greater extent, thereby attracting a pet's attention. The heat resistance and low-temperature resistance of E-TPU allow the toy ball 200 to maintain the above properties in different seasons across different regions.

Referring to FIGS. 1 and 2, in an embodiment, the elastic shell 1 includes a hard inner layer 11 and an elastic outer layer 12. The hard inner layer 11 defines the receiving cavity 101. The elastic outer layer 12 covers an outer side of the hard inner layer 11, and the elastic outer layer 12 is made of E-TPU.

In this embodiment, the hard inner layer 11 is spherical with the receiving cavity 101 inside. The hard inner layer 11 may be made of a hard plastic, for example acrylonitrile butadiene styrene (ABS), polycarbonate (PC), polyamide (PA, nylon), or polyoxymethylene (POM, acetal), and combinations thereof. The actuation module 2 is installed in the hard inner layer 11 so that the hard inner layer 11 can protect the actuation module 2 from being damaged. The elastic outer layer 12 is E-TPU and can be bonded to cover the outer side of the hard inner layer 11.

In an embodiment, an inner diameter of the hard inner layer 11 is equal to an outer diameter of the actuation module 2 so that the actuation module 2 can be stably installed in the hard inner layer 11 to form an integral assembly, thereby enabling the actuation module 2 to output a driving force to move the toy ball 200.

With the above configuration, the actuation module 2 is installed in the hard inner layer 11, and the elastic outer layer 12 covers the outside of the hard inner layer 11. This facilitates installation of the actuation module 2 in the toy ball 200 and allows the hard inner layer 11 to protect the actuation module 2. In addition, when the actuation module 2 outputs torque to press the elastic outer layer 12, the actuation module 2 drives the hard inner layer 11 to press the elastic outer layer 12, thereby improving the bouncing performance of the toy ball 200.

In an embodiment, when the toy ball 200 is too small in diameter, the toy ball 200 may be accidentally swallowed by the pet, and when the toy ball 200 is too large in diameter, the toy ball 200 may be difficult for the pet to grip with its mouth. Thus, an overall diameter of the toy ball 200 is 7 cm to 9.5 cm, and a thickness of the E-TPU elastic outer layer 12 is 7 mm to 30 mm. If the elastic shell 1 is too thin relative to the overall toy ball 200, the elasticity is insufficient and the bouncing height is low, reducing attractiveness to the pet. If the elastic shell 1 is too thick relative to the overall toy ball 200, the overall diameter becomes too large, making it difficult for the pet to grip.

In an embodiment, grooves 121 are formed on an outer surface of the elastic shell 1 to facilitate the pet for gripping the outer surface of the toy ball 200.

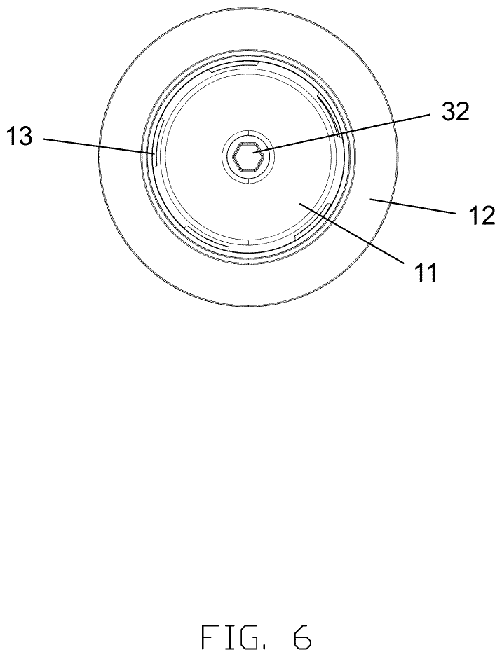

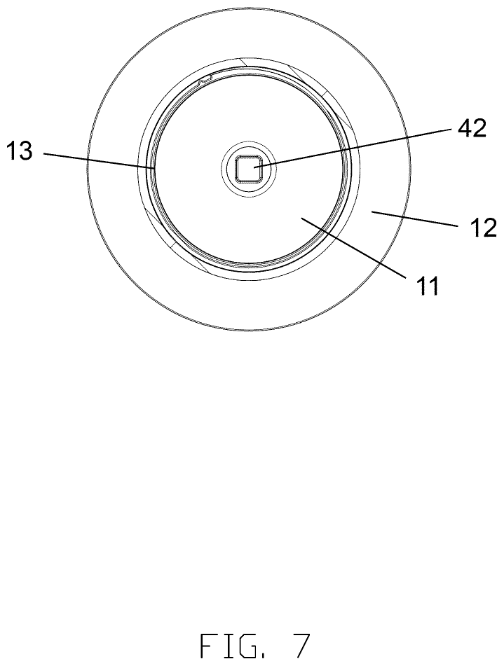

Referring to FIGS. 2, 6, and 7, in an embodiment, a portion of the hard inner layer 11 and a portion of the elastic outer layer 12 form a first half shell 111, and another portion of the hard inner layer 11 and another portion of the elastic outer layer 12 form a second half shell 112. The first half shell 111 and the second half shell 112 are connected by threads 13 to enclose and form the receiving cavity 101. Each of the first half shell 111 and the second half shell 112 is hemispherical.

In an embodiment, the threads 13 include an internal thread on the first half shell 111 and an external thread on the second half shell 112. The first half shell 111 and the second half shell 112 are detachably connected to each other by rotational engagement of the internal and external threads. The threads 13 are formed on the hard inner layers 11 of the first half shell 111 and the second half shell 112. During rotational tightening, the elastic outer layers 12 of the first and second half shells 111 and 112 gradually approach each other, and abutting regions of the two elastic outer layers 12 are compressed. As a result, an assembled seam is smaller, dust or other impurities are less likely to enter, and overall appearance is more complete.

When in use, the receiving cavity 101 of the elastic shell 1 may be opened. A user installs the actuation module 2 into the receiving cavity 101 so that the toy ball 200 can autonomously bounce or roll to attract attention from the pet. The user may also remove the actuation module 2 from the receiving cavity 101 and directly toss the toy ball 200 to interact with the pet.

Referring to FIGS. 2, 6, 7, and 8, in an embodiment, a waterproof ring 14 is arranged at the threaded connection between the first half shell 111 and the second half shell 112.

In an embodiment, an installation groove 113 is formed in the hard inner layer 11 of the second half shell 112 adjacent to the external thread. The installation groove 113 is used to mount the waterproof ring 14. When the first and second half shells 111 and 112 are connected by the threads 13, the waterproof ring 14 is clamped between the first and second half shells 111 and 112 so that the receiving cavity 101 becomes a sealed space.

With the above configuration, water resistance of the receiving cavity 101 is improved. The waterproof ring 14 prevents water from entering the receiving cavity 101 when the toy ball 200 falls into water, and saliva ingress during biting is also avoided, thereby protecting the actuation module 2. In addition, because the elastic outer layer 12 is made of low density E-TPU and the receiving cavity 101 is sealed, the toy ball 200 exhibits net buoyancy and floats on water, enabling the actuation module 2 to continue operating in aquatic environments and enriching play scenarios in pools, bathtubs, beaches, and shallow waters.

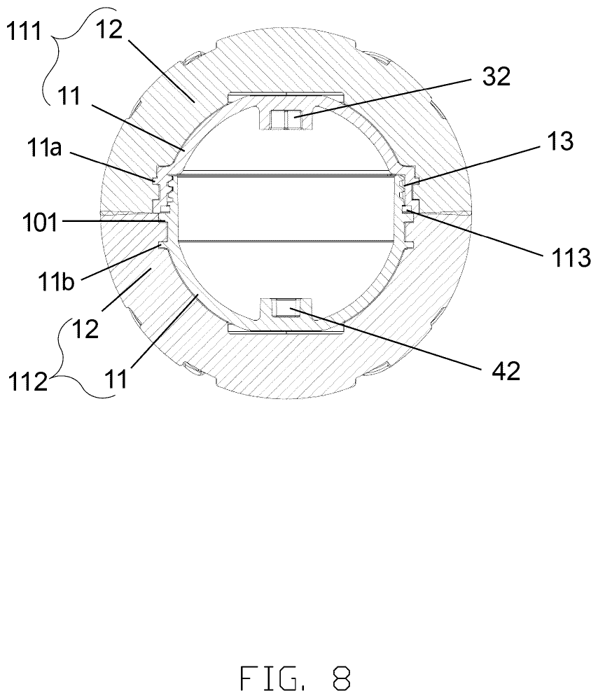

Referring to FIG. 8, the hard inner layer 11 of the first half shell 111 protrudes from the side facing away from the receiving cavity 101 to form a first engagement portion 11a. The first engagement portion 11a is embedded into the elastic outer layer 12 of the first half shell 111. Similarly, the elastic outer layer 12 of the second half shell 112 protrudes from the side facing away from the receiving cavity 101 to form a second engagement portion 12b. The second engagement portion 12b is embedded into the hard inner layer 11 of the second half shell 112. Thereby enhances the bonding strength between the inner layer 11 and the outer layer 12, and reducing the risk of delamination caused by pet biting.

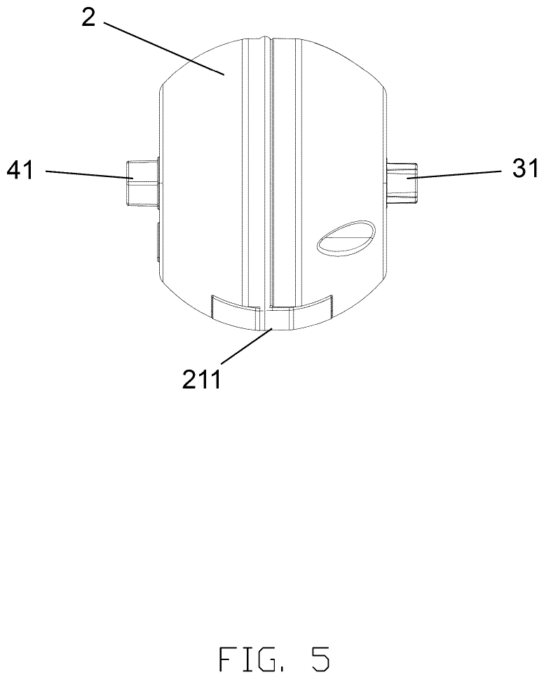

Referring to FIGS. 5, 6, and 7, in an embodiment, one positioning hole is formed on an inner side of each of the first half shell 111 and the second half shell 112. Two positioning posts are formed on two sides of the actuation module 2. One positioning post corresponds to one positioning hole so that the actuation module 2 is detachably connected to the first half shell 111 and the second half shell 112.

In this embodiment, the positioning holes on the inner sides of the hard inner layers 11 of the first and second half shells 111 and 112 are coaxial with each other, and the two positioning posts on two sides of the actuation module 2 are also coaxial with each other. The two positioning posts correspond to the two positioning holes, and the positioning posts and the positioning holes are connected by clearance-fitted.

With above configuration, during the installation of the actuation module 2, one positioning post on one side of the actuation module 2 is first aligned with and fitted into the positioning hole of the second half shell 112, and then the first half shell 111 is connected to the second half shell 112 by the threads 13. Meanwhile, the other positioning post is aligned with and fitted into the positioning hole of the first half shell 111. In this way, the connection between the actuation module 2 and the elastic shell 1 is more stable so that the actuation module 2 drives the elastic shell 1 to move to realize autonomous movement of the toy ball 200, and rotation of the actuation module 2 inside the receiving cavity 101 during operation is avoided.

Referring to FIGS. 5, 6, and 7, in an embodiment, the two positioning holes have different shapes. The two positioning posts are respectively adapted to corresponding positioning holes so that the actuation module 2 is detachably connected to the elastic shell 1.

The positioning hole of the first half shell 111 is a first positioning hole 32 whose cross-section is hexagonal. The positioning hole of the second half shell 112 is a second positioning hole 42 whose cross-section is square. The positioning posts on the two sides of the actuation module 2 are a first positioning post 31 and a second positioning post 41, respectively. The first positioning post 31, a regular hexagonal prism, matches the first positioning hole 32. The second positioning post 41, a regular quadrangular prism, matches the second positioning hole 42. Thereby, different positioning holes provide a fool-proof effect during assembly of the actuation module 2.

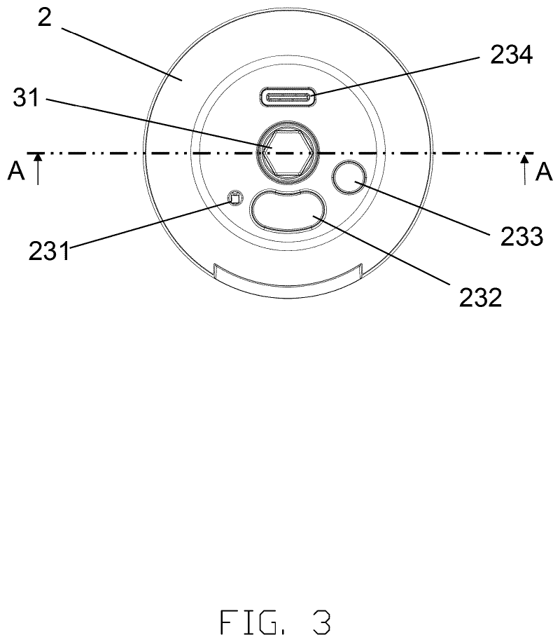

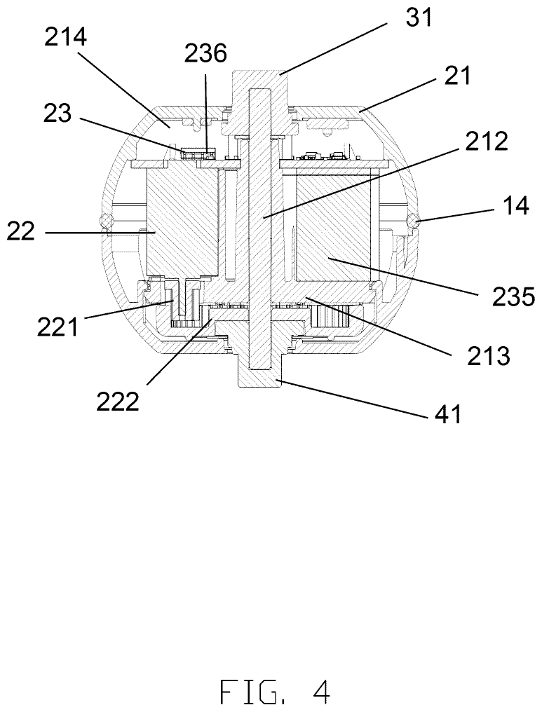

Referring to FIGS. 2, 3, and 4, in an embodiment, the actuation module 2 includes a housing 21, a motor 22, and a control assembly 23. The housing 21 defines a mounting chamber 214, a driven gear 222 is provided in the mounting chamber 214, and the housing 21 is detachably connected to the elastic shell 1. The motor 22 is disposed in the mounting chamber 214. An output end of the motor 22 is provided with a driving gear 221. The driving gear 221 meshes with the driven gear 222. The control assembly 23 is electrically connected to the motor 22.

In other embodiments, the hard inner layer 11 is provided with the driven gear 222. The actuation module 2 incudes a housing 21, a motor 22 and a control assembly 23. The housing 21 defines a mounting chamber 214, the motor 22 disposed in the mounting chamber 214 and includes a driving gear 221 at an output end of the motor 22. The driving gear 221 extending outside the housing 21 and configured to engage with the driven gear 222. The control assembly 23 electrically connected to the motor 22. Thereby, the driving gear 221 directly drives the elastic shell 1.

In this embodiment, an outer shape of the housing 21 is sphero-cylindrical, sized to match the receiving cavity 101, and the interior defines the mounting chamber 214. A rotating shaft 212 passes through the housing 21. Two ends of the rotating shaft 212 are provided with the first positioning post 31 and the second positioning post 41, respectively. A fixing frame 213 is also provided on the rotating shaft 212. The motor 22 is mounted on the fixing frame 213. The driving gear 221 at the output end of the motor 22 rotates to drive the driven gear 222 and the housing 21 to rotate so that the entire actuation module 2 drives the elastic shell 1 to move. The control assembly 23 includes a circuit board, wires, and other electronic components and controls start/stop of the motor 22, output power, and output time.

In an embodiment, the driven gear 222 is an internal ring gear whose teeth face a center of the mounting chamber 214. The driven gear 222 is arranged around an axis passing through the first positioning post 31 and the second positioning post 41. The driving gear 221 engages the driven gear 222 to drive the housing 21 to rotate about the rotating shaft 212.

In an embodiment, the motor 22 drives the housing 21 and the elastic shell 1 to move. By adjusting parameters such as start/stop of the motor 22, output power, and output time, the toy ball 200 performs different motion patterns, such as rolling or bouncing.

Referring to FIGS. 2, 3, and 4, in an embodiment, the actuation module 2 further includes a counterweight block 211 and a posture sensor 236. The counterweight block 211 is arranged on one side of the housing 21. The posture sensor 236 is electrically connected to the control assembly 23 and is used to detect changes in posture of the actuation module 2.

In this embodiment, the counterweight block 211 is embedded in a portion of an outer surface of the housing 21, and the motor 22 drives the counterweight block 211 to move about the rotating shaft 212. When the motor 22 drives the counterweight block 211 to rotate, or when a pet touches the toy ball 200 and causes the counterweight block 211 to move, the posture sensor 236 detects that a posture of the actuation module 2 has changed and then feeds back a signal to the control assembly 23. A program resides on the control assembly 23 and controls the motor 22 to change an output mode according to different signals.

In an embodiment, a rolling principle of the toy ball 200 is as follows: the motor 22 drives the housing 21 to rotate so that the counterweight block 211 connected to the housing 21 is lifted, thereby raising a center of gravity of the entire actuation module 2. At this time, the posture sensor 236 detects that the posture of the actuation module 2 has changed, that is, not the posture in which the counterweight block 211 is at a lowest point, and the motor 22 stops driving the housing 21 to rotate. Because the counterweight block 211 is located on one side of the housing 21, under gravity the counterweight block 211 moves downward to the lowest point, thereby driving the entire actuation module 2 and the elastic shell 1 to roll. At this time, the posture sensor 236 detects that the posture of the actuation module 2 corresponds to the counterweight block 211 at the lowest point, and the motor 22 continues to drive the actuation module 2 to rotate. When the posture sensor 236 detects a posture different from the posture in which the counterweight block 211 is at the lowest point, the motor 22 stops driving the housing 21 to rotate. Under the influence of the counterweight block 211, the entire actuation module 2 and the elastic shell 1 roll again. By repeating the above process, long-distance rolling of the toy ball 200 is realized.

In an embodiment, a bouncing principle of the toy ball 200 is as follows: the motor 22 drives the housing 21 to rotate at a constant speed so that the elastic shell 1 connected to the housing 21 also continuously rotates about the rotating shaft 212. During rapid rotation of the toy ball 200, centrifugal force causes the toy ball 200 to leave the ground briefly. Under gravity, during subsequent ground contact, the elastic shell 1, acted upon by elastic force and rotational centrifugal force, causes the toy ball 200 to leave the ground again and then contact the ground, repeating the cycle. With continuous cyclic driving by the actuation module 2, the bouncing of the toy ball 200 becomes more apparent.

With above configuration, an output mode of the motor 22 is set via the control assembly 23. After the toy ball 200 is turned on, if the pet touches the toy ball 200 to cause the toy ball 200 to roll, the posture sensor 236 detects a change in posture and sends a signal to the control assembly 23. The control assembly 23 controls the motor 22 to drive the toy ball 200 to roll, or the motor 22 continuously outputs torque to drive the toy ball 200 to bounce.

Referring to FIGS. 2, 3, and 4, in an embodiment, the actuation module 2 further includes a light sensor 231. The light sensor 231 is electrically connected to the control assembly 23 and is used to detect brightness inside the receiving cavity 101.

In this embodiment, the light sensor 231 is disposed on an outer surface of the actuation module 2, obtains external brightness signals, and feeds the signals back to the control assembly 23.

With above configuration, when the receiving cavity 101 is opened, the light sensor 231 detects illumination (LUX>0), and the control assembly 23 determines that the toy ball 200 is in an installation or removal state and therefore does not control the actuation module 2 to move. When the receiving cavity 101 is closed, the light sensor 231 detects very low illumination (LUX≈0, approximately zero), and the control assembly 23 determines that the toy ball 200 is in an operable state and then cooperates with the posture sensor 236 to control movement of the actuation module 2.

Referring to FIGS. 2, 3, and 4, in an embodiment, the actuation module 2 has multiple motion modes and further includes a button 232 and an indicator light 233. The button 232 is electrically connected to the control assembly 23 and is used to adjust the motion modes. The indicator light 233 is electrically connected to the control assembly 23 and is used to display a current motion mode.

In an embodiment, the motion modes include a passive mode, a normal mode, and a gentle mode. In the passive mode, only after the posture sensor 236 detects a change in posture of the toy ball 200, that is, after a pet has touched the toy ball 200, the control assembly 23 controls the toy ball 200 to bounce. In the normal mode, the control assembly 23 controls the toy ball 200 to intermittently bounce and roll. In the gentle mode, the control assembly 23 controls the toy ball 200 to roll for a long time and intermittently bounce for a short time, and a bouncing frequency is lower than in the normal mode.

In an embodiment, the button 232 on an outer side of the actuation module 2 switches the motion modes of the actuation module 2. The indicator light 233 indicates different motion modes by light color or blinking pattern. The indicator light 233 also displays a status of a battery 235. For example, when the toy ball 200 is in the passive mode, the light is green; in the normal mode, the light is blue; in the gentle mode, the light is purple. That is, different colors indicate different modes. Alternatively, when the toy ball 200 has low battery, the light is red and blinks quickly; when charging, the light is yellow and blinks slowly; when charging is complete, the light is green and steady. That is, different colors and different blinking rates indicate different battery states.

In an embodiment, a user sets a corresponding mode for the toy ball 200 through the button 232, and the indicator light 233 facilitates recognition of the status of the actuation module 2.

Referring to FIGS. 2, 3, and 4, in an embodiment, the actuation module 2 further includes a battery 235 and a charging interface 234. The battery 235 is electrically connected to the control assembly 23. The charging interface 234 is electrically connected to the battery 235.

In this embodiment, the charging interface 234 may be a Micro-USB interface or a USB Type-C interface.

With above configuration, the battery 235 supplies power to the actuation module 2. The charging interface 234 supplies power to the battery 235. The charging interface 234 also connects to a computer or another terminal to program settings of the actuation module 2.

The embodiments above shown and described above are examples. Many details are often found in the art, such as other features of toy ball 200 assemblies and actuation modules 2. Therefore, many such details are neither shown nor described. Even though numerous characteristics and advantages of the present technology have been set forth in the foregoing description, together with details of structure and function of the present disclosure, the disclosure is illustrative only, and changes may be made in detail, especially in matters of shape, size, and arrangement of parts within the principles of the present disclosure up to, and including the full extent established by the broad general meaning of the terms used in the claims. The embodiments described above may be modified within the scope of the claims.

What is claimed is:

1. A toy ball, comprising:
an elastic shell defining a receiving cavity; and
an actuation module configured to provide a driving force, mounted in the receiving cavity and detachably connected to the elastic shell;
wherein the elastic shell comprises expanded thermoplastic polyurethane (E-TPU).

2. The toy ball of claim 1, wherein the elastic shell comprises a hard inner layer defining the receiving cavity and an elastic outer layer covering an outer side of the hard inner layer, and the elastic outer layer comprises E-TPU.

3. The toy ball of claim 2, wherein a portion of the hard inner layer and a portion of the elastic outer layer form a first half shell, and another portion of the hard inner layer and another portion of the elastic outer layer form a second half shell, the first half shell and the second half shell are threadably connected to each other to enclose the receiving cavity.

4. The toy ball of claim 3, further comprising a waterproof ring, wherein the waterproof ring is disposed at a threaded connection between the first half shell and the second half shell.

5. The toy ball of claim 3, wherein an inner side of each of the first half shell and the second half shell defines a positioning hole, the actuation module comprises two positioning posts, and the two positioning posts are respectively engaged with the positioning hole of the first half shell and the positioning hole of the second half shell thereby detachably connecting the actuation module to the elastic shell.

6. The toy ball of claim 5, wherein the positioning hole of the first half shell and the positioning hole of the second half shell have different shapes.

7. The toy ball of claim 6, wherein the positioning hole of the first half shell has a hexagonal cross-section, the positioning hole of the second half shell has a square cross-section, the actuation module comprises a first positioning post and a second positioning post on opposite sides of the actuation module respectively matching the corresponding positioning holes, the first positioning post being a regular hexagonal prism and the second positioning post being a regular quadrangular prism.

8. The toy ball of claim 1, wherein the actuation module further comprises:
a housing defining a mounting chamber and comprising a driven gear on an inner wall of the mounting chamber;
a motor disposed in the mounting chamber and comprising a driving gear at an output end of the motor, the driving gear configured to engage with the driven gear; and
a control assembly electrically connected to the motor.

9. The toy ball of claim 8, further comprising a counterweight block and a posture sensor, wherein the counterweight block is disposed on one side of the housing, and the posture sensor is electrically connected to the control assembly and configured to detect posture changes of the actuation module.

10. The toy ball of claim 8, further comprising a light sensor, wherein the light sensor is electrically connected to the control assembly and configured to detect brightness within the receiving cavity.

11. The toy ball of claim 8, wherein the actuation module further comprises a plurality of motion modes and a button electrically connected to the control assembly, and the button is configured to switch the actuation module to one of the plurality of motion modes when the button is operated.

12. The toy ball of claim 11, further comprising an indicator light, wherein the indicator light is electrically connected to the control assembly and configured to display a selected one of the plurality of motion modes.

13. The toy ball of claim 8, further comprising a battery and a charging interface electrically connected to the battery, wherein the battery is electrically connected to the control assembly.

14. The toy ball of claim 1, wherein an outer surface of the elastic shell comprises at least one groove.

15. The toy ball of claim 2, wherein an overall diameter of the toy ball is in a range from 7 cm to 9.5 cm, and a thickness of the elastic outer layer is in a range from 7 mm to 30 mm.

16. The toy ball of claim 3, wherein the hard inner layer of the first half shell protrudes from a side facing away from the receiving cavity to form a first engagement portion, the first engagement portion is embedded into the elastic outer layer of the first half shell, the elastic outer layer of the second half shell protrudes from a side facing away from the receiving cavity to form a second engagement portion, the second engagement portion is embedded into the hard inner layer of the second half shell.

17. The toy ball of claim 3, wherein the hard inner layer is provided with a driven gear, the actuation module comprises:
a housing defines a mounting chamber;
a motor disposed in the mounting chamber and comprises a driving gear at an output end of the motor, the driving gear extending outside the housing and configured to engage with the driven gear; and
a control assembly electrically connected to the motor.

18. The toy ball of claim 4, wherein the second half shell defines an installation groove adjacent to an external thread, the waterproof ring is received in the installation groove and configured to seal the receiving cavity when the first half shell and the second half shell are connected.

19. The toy ball of claim 8, wherein the driven gear is an internal ring gear, the internal ring gear comprises a plurality of gear teeth facing toward a center of the mounting chamber and arranged around a central axis of the housing, and the driving gear is engaged with the driven gear to rotate the housing.

20. The toy ball of claim 8, wherein the actuation module further comprises a rotating shaft and a fixing frame, the rotating shaft passes through the housing, and the fixing frame is disposed on the rotating shaft to support the motor.
